(19) United States
(12) Patent Application Publication
(10) Pub. No.: US 2020/0207021 A1
(43) Pub. Date: Jul. 2, 2020

(54) MIXING HEAD SYSTEMS AND METHODS FOR FUSED DEPOSITION MODELING

(71) Applicant: BATTELLE MEMORIAL INSTITUTE, Richland, WA (US)

(72) Inventors: Josef F. Christ, Pasco, WA (US); Zachary C. Kennedy, Richland, WA (US); Rodrigo Guerrero, Prosser, WA (US)

(73) Assignee: BATTELLE MEMORIAL INSTITUTE, Richland, WA (US)

(21) Appl. No.: 16/725,558

(22) Filed: Dec. 23, 2019

Related U.S. Application Data
(60) Provisional application No. 62/786,239, filed on Dec. 28, 2018.

(51) Int. Cl. B29C 64/314; B01F 7/16; B01F 7/00; B01F 15/00; B01F 15/06; B33Y 10/00; B33Y 30/00; B33Y 40/10; B29C 64/118

(52) U.S. Cl. CPC B29C 64/314; B01F 7/16; B01F 7/00233; B01F 15/00844; B01F 15/00915; B01F 2215/0049; B33Y 10/00; B33Y 30/00; B33Y 40/10; B29C 64/118; B01F 2015/062; B01F 15/065

(57) ABSTRACT

Disclosed are systems and methods for mixing a plurality of materials for fused deposition modeling printing. The systems and methods can both mix and extrude FDM printer filaments. The mixing can be accomplished via a mixing element rotating in a heated chamber of the extruder's hot-end in order to achieve the shear forces to induce mixing of the molten plastics. Further, the mixing element can provide a secondary driving mechanism to assist with extruding the extrudate.

### PRIORITY

This invention claims priority from a provisional patent application 62/786,239 entitled A MIXING HEAD FOR FUSED DEPOSITION MODELING, filed Dec. 28, 2018.

### ACKNOWLEDGEMENT OF GOVERNMENT SUPPORT

This invention was made with Government support under Contract DE-AC0576RL01830 awarded by the U.S. Department of Energy. The Government has certain rights in the invention.

### FIELD

The present disclosure generally relates to fused deposition modeling (FDM) printing and more particularly to FDM printing of composite or multiple feedstock materials.

### BACKGROUND

Additive manufacturing (AM) has grown rapidly in both the industrial and research sectors and contributes to the production of functional parts with high complexities and unique form factors. Relative to traditional manufacturing approaches, AM may generate less material waste and may be more receptive to iterative design and fabrication process.

Fused filament fabrication (FFF) is a type of AM technology that is compatible with a wide range of shelf-stable material feedstocks and enables production of 3D objects over a range of material compositions at low-costs relative to traditional manufacturing approaches. A variety of materials may be used in conjunction with FFF. However, many applications exist where specific mechanical, thermal, or chemical properties are needed that cannot be met with the available feedstock selection.

### BRIEF DESCRIPTION OF THE DRAWINGS

FIG. 1 depicts an external diagram of a mixing extruder, according to an embodiment described herein.

FIG. 2 depicts examples of mixing element designs, according to an embodiment described herein.

FIG. 3 depicts an internal diagram of the mixing extruder, according to an embodiment described herein.

FIG. 4 depicts a plurality of cross-sectional optical images of the distribution of extruded material as a function of mixing element design and rotational speed, according to an embodiment described herein.

FIG. 5 depicts examples of tensile bars printed with individual layers in a perpendicular and parallel to the applied tensile forces, according to an embodiment described herein.

FIG. 6A depicts a visual graph of a stress strain plot for the parallel printed samples and FIG. 6B depicts optical images of post tensile pulled DB-1000 and NM samples.

FIG. 7A depicts an image of various blended materials, FIG. 7B depicts TGA data recorded on single printed TPU/PLA strands as a function of TPU:PLA ratio, and FIG. 7C depicts TGA data recorded similarly on single printed Nylon/PLA strands as a function of Nylon:PLA ratio.

### SUMMARY

Disclosed herein and in the attachments are FDM mixing extruder systems and methods for mixing a composite filament or multiple filaments in embodiments of FDM mixing extruder systems. The systems and methods can both mix and extrude.

FDM printer filaments are thermoplastic-based feedstock for FDM printers. There are different types of filaments available with different properties, which may require different temperatures to print. Two filaments, such as filaments composed of two different materials, may be mixed to achieve a particular homogeneity and/or particular consistency. Described herein are mixing head systems and methods for FDM. The mixing can be accomplished via a mixing element rotating in a heated chamber of the extruder's hot-end in order to achieve the shear forces necessary to induce mixing of the molten plastics. Further, the mixing element can provide a secondary driving mechanism to assist with extruding highly viscous polymers.

Embodiments described herein mix, in controllable ratios, a plurality of materials together. Examples include, but are not limited to, a conductive and a non-conductive filament, a soluble and an insoluble filament, and/or a flexible and an inflexible filament. In some of these examples, the mixed materials were very dissimilar in melting points and/or dissimilar compositions, yet still demonstrate homogenous mixing.

Additionally, or alternatively, the disclosed embodiments provide a method for extruding novel extrudates. Further, embodiments described herein can be a drop-in design that is compatible with current FDM 3D printers with minimal modifications.

The mixing head system and methods disclosed herein may provide several advantages, such as demonstrably homogeneous and tunable mixing of the input filaments, and/or increased extrusion pressures to extrude filaments that are viscous and/or difficult for convention filament drive mechanisms to feed. Mixing and extruding the filaments via the mixing head system and methods can achieve better mechanical properties. Absent homogeneous and/or tunable mixing of the filaments, the resulting composition of filament(s) may be rigid, easily break, or display non-uniform performance behavior.

### DETAILED DESCRIPTION

FFF print heads include a feeding mechanism, and a melting chamber, usually referred to as a hot-end. While the extruder and hot-end can vary significantly between manufacturers, these elements provide the driving force for the polymer, thereby melting and extruding the polymer out of a nozzle.

FFF utilizes thermoplastic-based feedstocks which may print commodity polymers such as, for example, acrylonitrile butadiene styrene (ABS), polylactic acid (PLA), and polyamides (e.g., nylons). Recently, high-performance FFF feedstocks have been introduced such as homopolymers polyetheretherketone (PEEK) and polyphenylene sulfide (PPS). Composite material, such as carbon-fiber reinforced-thermoplastic and metal filled polymer, are also available. Development of new “designer” and/or advanced functional FFF-compatible materials is significant to further the growth and application of the technology.

FFF-compatible polymers can be processed with additives (e.g., lubricants, antioxidants, plasticizers) to modulate rheological, thermal, and mechanical properties. The FFF filament(s) may be used as feedstock input material. By way of example, the FFF filament(s) may have a diameter of approximately 1.75 mm.

A mixing nozzle is a print-head designed to have multiple inputs that feed into a single melting chamber followed by extrusion out of a single nozzle. This enables the printing of multiple filaments in tandem. For example, color mixing can result via tandem polymer extrusion. However, existing mixing nozzles do not achieve homogeneous mixing of the polymers due to, for example, high viscosity resulting in laminar flow. The resulting insufficient mixing is not adequate for situations in which greater polymer blending is needed, particularly when the polymers are of dissimilar compositions.

Described herein are fused deposition modeling (FDM) mixing extruder systems and methods for mixing a composite filament or multiple filaments. The systems and methods can both mix and extrude FDM printer filaments. In particular, the mixing of two or more FFF feedstocks at the time of printing within individual printed layers may be accomplished with increased efficiency and/or consistency.

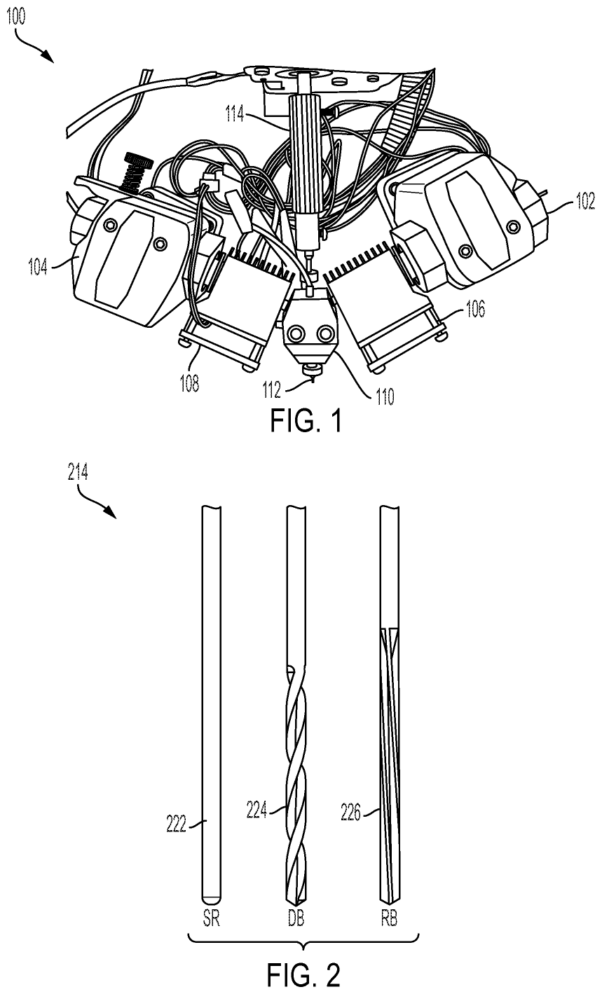

Referring to the figures, FIG. 1 depicts an external diagram of a mixing extruder. As illustrated in FIG. 1, the mixing extruder 100 includes a drive mechanism 102, a heatsink 106, a heater block 110, and a mixing element 114. A motor (not shown) can be connected to provide a power source. It will be appreciated that additional or fewer components may be included in various embodiments. For example, as illustrated in FIG. 1, a second drive mechanism 104 and a second heatsink 108 are depicted and may operate identical/similar to the first drive mechanism 102 and first heat sink 106, respectively.

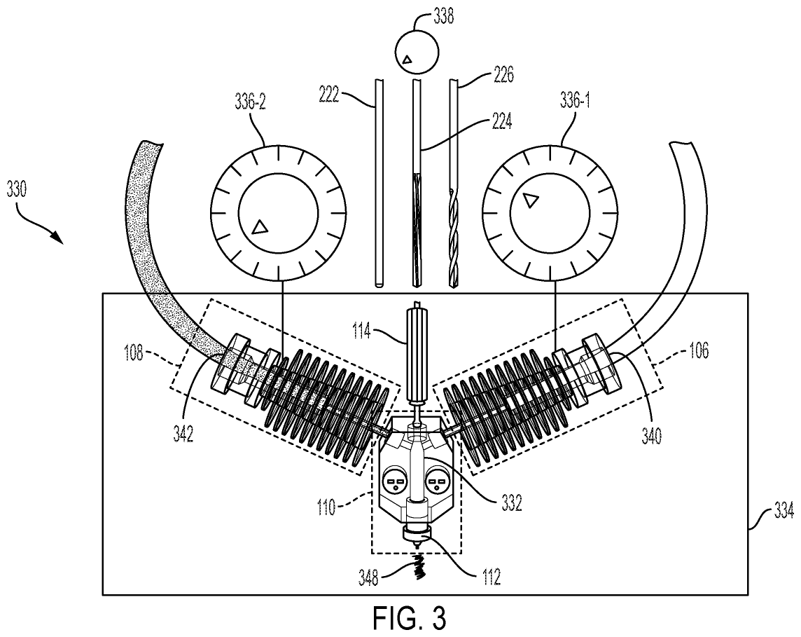

The drive mechanism 102 may be connected to the motor (not shown) and provides torque force and/or rotational drive to filament (not shown, discussed further in FIG. 3) within the heatsink 106. The heatsink 106 transfers heat to melt the filament, while the drive mechanism 102 provides the force to extrude the filament to the heater block 110. In some instances, the filament may be partially, substantially, or completely melted within the heatsink 106. The heater block 110 receives the filament. The heater block 110 may be connected to a mixing element 114, which may also be connected to a motor (not shown). The mixing element 114 can be rotated to blend the filament(s) in a mixing chamber within heater block 110, as described further herein. The FFF filament(s) can be printed through the mixing nozzle 112 of the heater block 110. That is, the extruded material (e.g., blended composition) may be extruded from the mixing nozzle 112. The mixing nozzle 112 may be, in some examples, a 400 μm brass nozzle.

The mixing element 114 is an elongated rod, which can be smooth, tapered, and/or helical. FIG. 2 illustrates examples of mixing element designs 214. In some embodiments, the mixing element 114 may be a smooth rod 222, a drill bit 224, and/or a reamer bit 226. The smooth rod 222 may be a metal rod designed in the pattern of a round bar, rectangular or flat bars, hexagons, and or other patterns of bar stock. The drill bit 226 may include a spiral, point angle, lip angle, and/or a varied functional length. The reamer bit 226 may include a tapered end and/or a spiral flute. In some embodiments, the reamer bit 226 is a four-fluted reamer bit. The various mixing element designs 214 may be comprised of various materials, such as but not limited to, metals and alloys.

FIG. 3 depicts an internal diagram 330 of the mixing extruder, such as that depicted in FIG. 1.

The mixing chamber 332 may be referred to collectively as a hot-end 334. The hot-end includes two inputs and a single output. The hot-end 334 can include six components: a heater-block 110, two heat breaks 102 and 104, a heat sink 106, 108, a mixing element 114, a mixing element gasket (not shown), and a mixing nozzle 112. In some embodiments, an interior surface of the mixing chamber 332 includes a roughened texture. The roughened texture provides an adjusted internal surface geometry that may induce further shear force within the mixing chamber 332, which provides increased mixing capabilities.

The mixing chamber 332 includes at least two filament input feedthroughs, such as the first heatsink 106 and the second heatsink 108 (described in FIG. 1 and FIG. 3), and a third input where the mixing element 114 is installed. The third input is a non-filament input, located at least partially within the mixing chamber 332, and can enable the insertion of different mixing element 114 designs (e.g., see 214 in FIG. 2) to be run down the length of the mixing chamber 332 within the heater block (e.g., 110 in FIG. 1). In an embodiment, a second motor (not shown), such as a stepper motor or a variable rotational motor, that is separate from the drive motor, may operate the rotation of the mixing element 114 within the mixing chamber 332.

In some embodiments, tunable parameters of the mixing chamber 332 can include polymer feed rate, input polymer ratio, and mixing element speed. The polymer(s) feed rate (e.g., rate of flow) and/or the polymer ratio (e.g., amount of filament) can be independently controlled via tunable component 336-1 and 336-2. Additionally, the mixing speed can be adjusted via tunable component 338. Each of the tunable components 336-1, 336-2, and 338 may operate independently.

The polymer feed rate and polymer ratio operated by tunable components 336-1 and 336-2 may tune the composition of the extruded material 348 (e.g., the particular extrusion blend) from the mixing nozzle 112. By way of example, one may adjust the first filament ratio and second filament ratio to be a ratio of 25:75, while the mixing speed of the mixing element 114 is set to 500 steps/mm, to result in an extruded material 348 having a rigid interior and flexible exterior. Additionally, or alternatively, the extruded material 348 may be tuned to achieve a particular conductivity, as discussed further herein with respect to Table 2. In some examples, the mixing rate can be operated such that it maintains a proportional mixing speed to the polymer flow rate (e.g., tunable components 336-1, 336-2 is proportional to tunable component 338).

The mixing speed controlled by tunable component 338 may control the amount of mixing of the first filament 340 and second filament 342, which may tune distribution of the extruded material 348. For example, the first filament 340 and second filament 342 may have a 50/50 ratio or any combined ratio equaling 100 percent of the extruded material 348. In some embodiments, the second motor (not shown) may be connected to the printer's controller board (not shown), which can be controlled to maintain proportional mixing speeds to the polymer flow rate.

The mixing chamber 332 (e.g., the hot-end) design enables simple exchange of mixing elements 114 with different physical features (i.e., different mixing element designs, see FIG. 2) to mix the first filament 336-1 and second filament 336-2 to result in a particular extruded material 348.

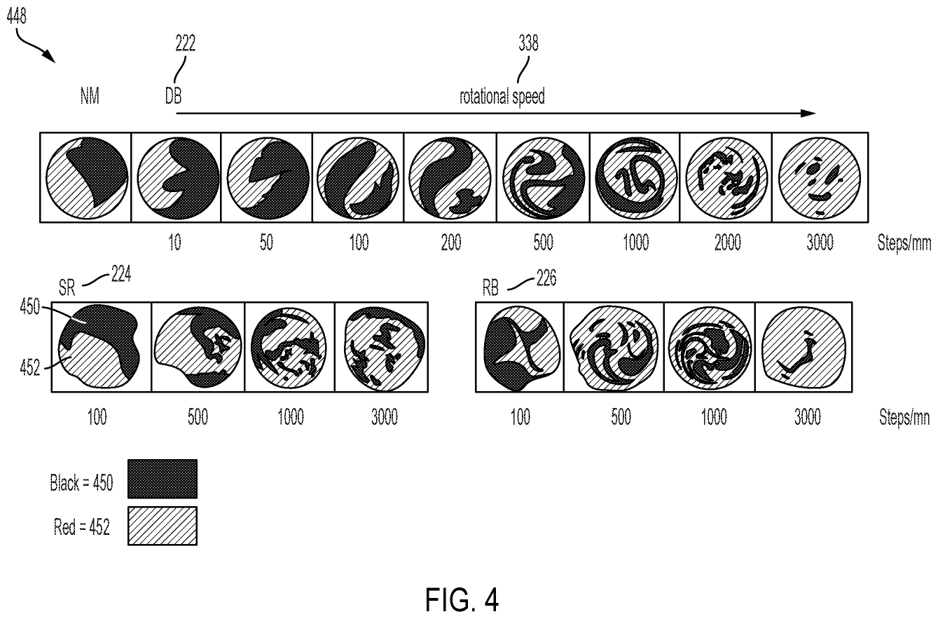

FIG. 4 depicts a plurality of cross-sectional optical images of the distribution of extruded material 448 as a function of mixing element design (e.g., 214 in FIG. 2) and rotational speed (e.g., 338 in FIG. 3) within the mixing chamber (e.g., 332 in FIG. 3).

A first filament 450 and a second filament 452 were extruded through the nozzle (e.g., 112 in FIGS. 1 and 3) of the mixing chamber (e.g., 332 in FIG. 3). By way of example, the filament ratio (e.g., 336-1, 336-2) was set at 50:50, with TPU being the first filament 450 and PLA being the second filament 452, which were blended and printed through a 400 μm nozzle, which resulted in approximately 600-900 μm diameter of extruded material as a result of die swelling. Different colored materials were selected to provide optical contrast and characterize the extent of material blending, as illustrated. The cross-sectional distribution of the input feedstocks and consistent patterns based on geometric designs of the mixing element were illustrated.

As shown in FIG. 4, as the rotational velocity steps/mm of the mixing element increased, the amount of mixing between the first filament 450 and second filament 452 increased. Based on the 3000 steps/mm speed, the smooth rod 222 mixing element resulted in the least amount of mixing, while the drill bit 224 and reamer bit 226 mixing elements resulted in increased amounts of mixed extruded material 448. With a greater mixing at 3000 steps/mm using the drill bit 224 and reamer bit 226, the blends have more completely merged in color and with only minor distinct phase patterns at this resolution.

It is notable that by adjusting the mixing element geometries and rotational speed, a particular cross-pattern or distribution of the at least two filaments in the blended material may be turned to material performance. For example, the extruded material 448 having a rigid interior and flexible exterior, or vice versa.

As discussed further herein, the first filament may be different from the second filament. Additionally, or alternatively, in some examples, the first filament and the second filament may be the same material. For example, the first filament may be a flexible material, while the second material is a rigid or conductive material, such that the extruded material may be a combination of conductive, flexible, or rigid material. In some embodiments, the filament ratio may be varied, such that the first filament is greater than the second filament, or vice versa. For example, the first filament to second filament ratio may be 75:25 ratio, or vice versa.

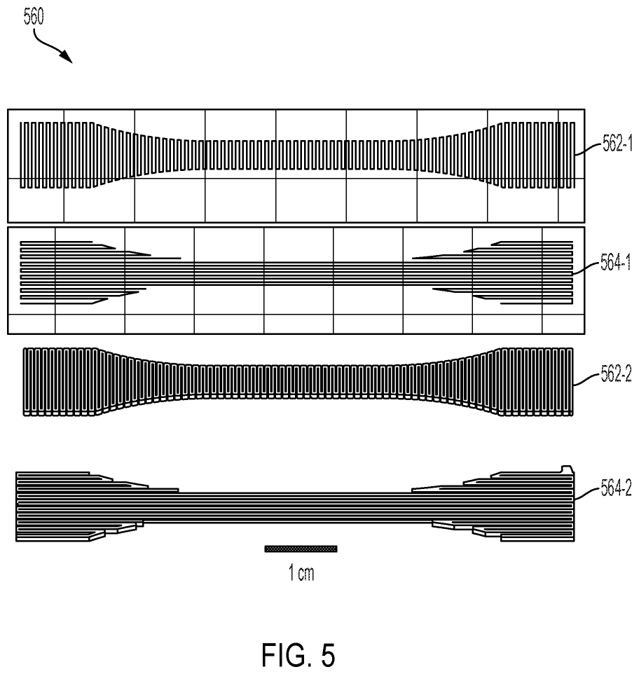

FIG. 5 depicts examples of tensile bars printed with individual layers in a perpendicular and parallel to the applied tensile forces.

The mixed (50:50) TPU/PLA tensile bar samples were printed with 400 μm resolution without a mixer and with each of the three mixer element designs (e.g., 214 in FIG. 2) rotating at a fixed speed of 1000 steps/mm. Tensile bars with each printing condition were printed with individual layers aligned parallel 562-1, 562-2 and perpendicular 564-1, 564-2 to the applied tensile stress. As shown in Table 1, below, the average ultimate tensile strengths (UTS) and Young's modulus (YM) were calculated from tensile tests on five specimens per mixer design and print path.

TABLE 1
Mechanical properties of (50:50)-TPU/PLA tensile bar samples as a function of mixer type and print path.

| | | | Perpendicular | | | | | |
|---|---|---|---|---|---|---|---|---|
| | Perpendicular | | Print Pain, | | Parallel Print | | Parallel Print Path, | |
| Mixer | Print Path, UTS | (% Change | Young's Modulus | (% Change | Path, UTS | (% Change | Young's Modulus | (% Change |
| Design | (MPa) | No Mixer) | (MPa) | No Mixer) | (MPa) | No Mixer) | (MPa) | No Mixer) |
| No mixer | 17.87 ± 1.01 | (0) | 586.37 ± 138.22 | (0) | 35.47 ± 1.00 | (0) | 707.12 ± 96.48 | (0) |
| SR-1000 | 17.80 ± 1.71 | (−0.4) | 536.52 ± 22.19 | (−8.5) | 38.16 ± 1.53 | (7.6) | 888.76 ± 94.16 | (25.7) |
| DB-1000 | 16.28 ± 1.28 | (−8.9) | 500.12 ± 64.19 | (−14.7) | 39.37 ± 1.42 | (11.0) | 755.03 ± 85.96 | (6.7) |
| RB-1000 | 18.74 ± 0.65 | (4.8) | 555.41 ± 41.54 | (−5.2) | 38.79 ± 1.18 | (9.4) | 870.82 ± 123.52 | (23.1) |

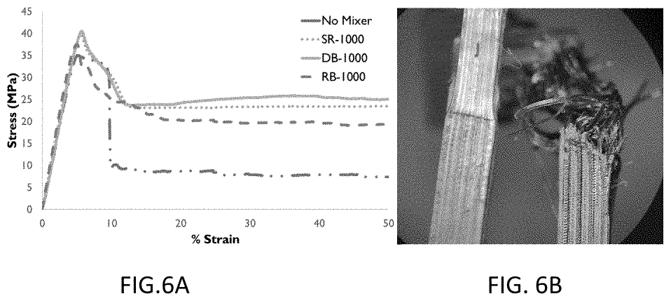

Comparing the results of the mixed samples to the unmixed sample, there is a change in mechanical performance. During tensile pulling, the unmixed samples demonstrated significant interlayer delamination and tearing.
The stress strain plot shown in FIG. 6A depicts that the unmixed sample failed more rapidly than the unmixed samples. As shown in FIG. 6B, this was attributed to the PLA portion of the extruded strands failing before the TPU portions, unlike the mixed sample, which behaved more like a singular material throughout the pull test. While the samples may behave similarly in their bulk material properties, at the interlayer level, there is a significant difference in behavior between the mixed and unmixed samples.

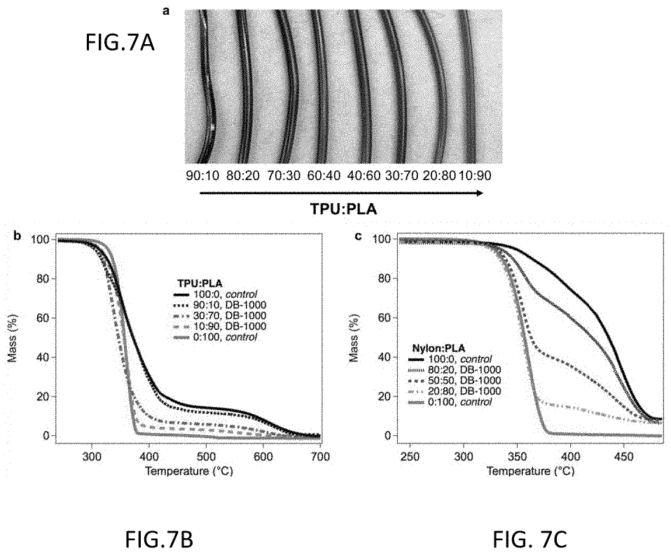

The hot-end and mixing hardware can be interfaced to the slicing software for fine control of not only the rotational velocity of the mixing element but also to enable seamless tuning of the blend composition by modulating the feed ratios of the input filaments. As depicted in FIG. 7A, the single-layer printed TPU/PLA samples were produced using the DB-1000 mixer conditions over a wide range of compositions with input feed ratios programmed from (90:10)-TPU/PLA to (10:90)-TPU/PLA.

As illustrated in FIG. 7A, the blended material transitioned from black (from TPU) to brown to red (from PLA) as the ratio of the PLA increased in the sample. This suggests the actual composition achieved correlated with the programmed feed ratio of the two feedstocks. To further assess the composition obtained, FIG. 7B depicts the TGA performed on the printed TPU/PLA blends (in air, 5° C./min ramp rate) and pure printed sample controls. The onset and primary thermal decomposition of the two constituent materials can overlap significantly. However, pure PLA degrades nearly completely (>99.4% mass loss) by 425° C. in these conditions, whereas the polyurethane structure of the pure TPU has a mass loss of 79.5% by the same temperature. As the PLA concentration in the printed blends increased, the total mass loss increased accordingly at this temperature point in the analysis to provide support for compositional control.

In both sets of blends, mixed samples were prepared using the DB geometry with a rotational speed of 1000 steps/mm.

The mixing system provides direct blending of a wide-array of filament feedstocks and to accelerate the production of FFF objects with new compositions and properties. To this end, the hardware was used to print blended Nylon/PLA materials using the DB mixing rotating at 1000 steps/mm (DB-1000). The blending methodology detailed in the TPU/PLA samples was applied to the second pair of feedstocks. The input feed ratio of the two components was tuned to produce samples with compositions from (80:20)-Nylon/PLA to (20:80)-Nylon/PLA. FIG. 7C depicts TGA analysis used to monitor first the thermal decomposition of PLA followed by the decomposition of the Nylon contained in the printed blends. As these thermal transitions are less overlapped than the TPU/PLA samples, it was readily apparent the changes in Nylon/PLA composition programmed into the system were reflected in the actual printed samples.

In some embodiments, a functionalized material as an input such as one with filler added. That is, in some examples, a conductive filament may be included. The addition of a semi-conductive filament input was tested in order to characterize how the mixing head interacts with functionalized, composite feedstocks. Table 2 outlines the relationship between mixing element geometry, speed, and the mixing behavior of a conductive PLA/PLA blend. In this example, the conductive PLA (Functionalize) uses multiwalled carbon nanotubes (MWCNTs) to imbue the PLA with semi-conductive properties (average two-point resistance=53 ohm/cm). The addition of MWCNTs provides electrical properties to polymers through the conductive network matrix produced by the MWCNTs. It has also been shown that the conductivity of the resulting composite polymer is highly influenced by both the orientation and dispersion of the MWCNTs.

As shown in Table 2 below with respect to the 50:50 mixtures, there is little change in the resistance except for the SR samples, which show a decrease in resistance of almost 2.6 times that of the unmixed samples. As the ratio biases towards the pure PLA in the (30:70)-CNT-PLA/PLA mixtures, the change in resistance becomes far more prominent. The SR samples once again show a decrease in resistance while the DB and RB samples show a significant increase in resistance. The SR appears to be better influencing the dispersion and orientation of the MWCNTs as compared to the DB and RB mixing elements which both appear to be inducing far more dispersive mixing. As the mixing element speed is increased the shear force acting on the polymer increases, which has been shown to improve additive dispersion within polymer composites. Based on the DB and RB results, it either indicates that the MWCNTs are being well dispersed into the added, nonconductive PLA, or the MWCNTs are being oriented in a common direction, resulting in an overall decrease in the conductance of the extruded material (e.g., the mixed material).

TABLE 2
Comparison of sample resistivity as a function of mixer
design and feed ratio in printed CNT-PLA/PLA blends.

| | CNT-PLA/PLA | Resistance |
|---|---|---|
| Mixer Design | feed ratio | (kohm/cm) |
| No mixer | 50:50 | 2.28 ± 0.13 |
| SR-1000 | 50:50 | 0.87 ± 0.14 |
| DB-1000 | 50:50 | 2.19 ± 0.17 |
| RB-1000 | 50:50 | 2.01 ± 0.05 |
| No mixer | 100:0 | 0.053 ± 0.001 |
| RB-1000 | 70:30 | 0.35 ± 0.03 |
| No mixer | 30:70 | 4.23 ± 0.95 |
| SR-1000 | 30:70 | 3.64 ± 0.40 |
| DB-1000 | 30:70 | 12.35 ± 2.99 |
| RB-1000 | 30:70 | 29.41 ± 3.69 |

As described herein, the hot-end mixing element hardware is designed to be compatible with standard FFF printers. By interfacing the hardware with the slicing software, a user can tune the rotational speed of the mixing element and input polymer flow rates simultaneously. This control introduces a unique approach to systematically tune the polymer blend composition (i.e. ratio) and internal distribution of the two input materials within individual printed layers during a build. The capability of the hardware was demonstrated by the printing of mechanically, mixed blends where the two input polymers were different thermoplastics, specifically TPU/PLA and Nylon/PLA. The use of an active mixing extruder allowed for the efficient generation and screening of polymer composites with varying compositions and loadings of filler. To this end, MWCNT-doped PLA was blended with PLA at different ratios and with varying mixing element designs. Each of these parameters contribute to the resulting conductivity observed in the printed materials as a result of the amount and distribution of the MWCNTs present.

The embodiments described herein illustrate the active blending of two input thermoplastic-based filaments directly in a single-step during a FFF printing process. More traditional development of an FFF blend or composite feedstock requires multiple steps where the desired composite is first obtained by blending for example in a twin-screw extruder and spooled into filament prior to printing. Using drill-bit and reamer-bit mixer elements operating at high-rotational speeds, the two input phases were shown to be highly-mixed on a practical scale.

The purpose of this disclosure and the related attachments is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. Neither the description nor the abstract is intended to define the invention of the application, which is measured by the claims, nor is it intended to be limiting as to the scope of the claims in any way.

The following and attached explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description, the attachments, and the claims.

Unless otherwise indicated, all numbers expressing quantities of components, weights, compositional ratios, rates, percentages, temperatures, times, and so forth, as used in the specification, the attachments, or the claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

In view of the many possible embodiments to which the principles of the disclosed invention may be applied, it should be recognized that the illustrated embodiments included herein are only preferred examples of the invention and should not be taken as limiting the scope of the invention. Rather, the scope of the invention is defined by the following claims. We therefore claim as our invention all that comes within the scope and spirit of these claims.

What is claimed:

1. A fused deposition modeling (FDM) printer mixing extruder comprising:
a mixing chamber having an outlet for a feedstock filament and an outlet nozzle to extrudate; and
a mixing element in the mixing chamber, the mixing element includes a bit that translates rotational motion to linear motion.

2. The mixing extruder of claim 1, wherein the mixing element blends a first filament and a second filament, wherein the first filament is different from the second filament.

3. The mixing extruder of claim 2, wherein the blended first filament and second filament form an extruded material extruded from the nozzle, wherein the extruded material is combination of conductive, flexible, or rigid.

4. The mixing extruder of claim 1, wherein the bit of the mixing element includes a smooth rod, a helical flute, or a drill bit.

5. The mixing extruder of claim 1, further comprising a motor connected to the mixing element and configured to rotate the mixing element.

6. The mixing extruder of claim 5, wherein the mixing element and the motor are configured to provide a drive force for filament from the inlet to the outlet nozzle.

7. The mixing extruder of claim 1, wherein an interior surface of the mixing chamber includes a roughened texture.

8. The mixing extruder of claim 1, wherein an interior surface of the mixing chamber includes a helical flute.

9. The mixing extruder of claim 1, wherein an interior surface of the mixing chamber includes a baffle.

10. A FDM printer system comprising:
a mixing chamber having an inlet for a feedstock filament and an outlet nozzle to extrudate;
a filament drive mechanism to provide feedstock filament to the inlet;
a mixing element in the mixing chamber, the mixing element includes a bit that translates rotational motion to linear motion;
a motor connected to the mixing element and configured to rotate the mixing element;
a heater block to heat the mixing chamber; and
a heat sink located between the heater block and the filament drive mechanism.

11. The FDM printer system of claim 10, wherein the mixing element includes a smooth rod.

12. The FDM printer system of claim 10, wherein the mixing element includes a helical flute.

13. The FDM printer system of claim 10, wherein the mixing element includes a drill bit.

14. A method comprising:
heating a mixing chamber with a heater block;
mixing a plurality of materials in the mixing chamber with a rotating mixing element positioned in the mixing chamber, the mixing element includes a bit translating rotational motion to linear motion; and
providing, via the mixing element, a driving force to extrudate out of the mixing chamber through an outlet nozzle.

15. The method of claim 14, wherein mixing the plurality of materials is varied by mixing speed and filament ratio to obtain a particular blend composition forming the extrudate.

16. The method of claim 15, wherein the mixing speed and filament ratio are independently controlled.

17. The method of claim 15, further comprising modifying the filament ratio in the particular blend composition in response to the viscosity of one of the filaments.

18. The method of claim 14, further comprising selecting the bit of the mixing element from among a smooth rod, reamer bit, or drill bit.

19. The method of claim 14, wherein the plurality of materials includes a first filament and a second filament, the first filament being different from the second filament, and varying the filament ratio such that the first filament is greater than the second filament.

20. The method of claim 14, further comprising changing the mixing speed of the mixing element in response to one of the filaments among the plurality of materials.
